(19) United States
(12) Patent Application Publication
(10) Pub. No.: US 2023/0142280 A1
(43) Pub. Date: May 11, 2023

(54) CAPACITIVE SENSING IDENTIFICATION TAG

(71) Applicant: NANOBIT TECH. CO., LTD., Taoyuan City (TW)

(72) Inventors: Te-Fong CHAN, Taoyuan City (TW); Fu-Tien KU, Taoyuan City (TW); Yu-Yang CHANG, Taoyuan City (TW); Sung-Chien HUANG, Taoyuan City (TW); Hsiou-Ming LIU, Taoyuan City (TW)

(21) Appl. No.: 17/546,015

(22) Filed: Dec. 8, 2021

(30) Foreign Application Priority Data
Nov. 10, 2021 (TW) 110141831

(51) Int. Cl. G06K 7/08; G06F 3/044; H04B 5/00; G06K 19/067

(52) U.S. Cl. CPC G06K 7/089; G06F 3/044; H04B 5/0025; G06K 19/067

(57) ABSTRACT

A capacitive sensing identification tag includes a substrate and a touch sensing layer disposed on one side of the substrate. The touch sensing layer includes high-sensing regions and low-sensing regions with different shapes. Both the high-sensing regions and the low-sensing regions have different stacked conductive layers and dielectric layers. A difference between the high-sensing regions and the low-sensing regions is that each of the high-sensing regions contains a dielectric layer, while each of the low-sensing regions does not. The capacitive sensing identification tag achieves an effect of sampling and identification of a touch panel by a capacitive sensing quantity that is different from a capacitive touch panel. And the capacitive sensing identification tag will not cause a difference in color or light transmittance between the high-sensing regions and the low-sensing regions, so there is no visible difference between the high-sensing regions and the low-sensing regions.

### BACKGROUND

### Technical Field

The present disclosure is related to an inductive identification tag, in particular to a capacitive sensing identification tag with high-sensing regions and low-sensing regions.

### Description of Related Art

In recent years, identification tags such as barcodes, RFID (radio frequency identification), NFC (near-field communication), etc. have been widely used in logistics management, commodity management, medical management and other fields because they are convenient to read with specific handheld devices (such as mobile phones). Based on characteristics about non-contact and easy-to-use of identification tags, radio frequency identification systems such as RFID and NFC identification systems have gradually replaced barcode scanning identification systems.

A capacitive sensing identification tag in prior art may use a capacitive touch panel as a sensing detection tool. For example, US patent No. U.S. Pat. No. 8,497,850B2 and Taiwan patent No. 1482097 disclose a tag for identification. An identification tag made by coating a conductive material on a substrate may be applied to a capacitive touch panel to change a capacitance of a panel. When a reading device of the capacitive touch panel, such as a panel of a mobile phone or a tablet, is disposed on the capacitive touch panel, a difference in sensing amount produced by a capacitive sensing identification tag at a specific position of the capacitive touch panel. Therefore, the capacitive sensing identification tag generates specific pattern structures corresponding to different capacitance sensing values due to a difference in configuration of conductive layers, and the specific pattern structures are used as the identification of a specific message. Further, in order to improve sampling sensing result of the capacitive sensing identification tags by the panel of a mobile phone or a tablet with capacitive touch sensing functions, a dielectric layer is sandwiched between an upper conductive layer and a lower conductive layer to increase a sensing capacitance of the panel being read. Please refer to Taiwan patent No. M594257.

A structure of the capacitive sensing identification tags is similar to a parallel plate capacitor, which includes a substrate and two conductive layers disposed on two respective sides of the substrate. Both two conductive layers include a high dielectric constant (DK), and a low dielectric loss medium isolates the two conductive layers to form a planar capacitor unit structure. Each capacitor unit is printed or etched to form various types of capacitor unit patterns to form a capacitor sensing region, and a hollow area between compatible capacitor units is a non-sensing region. However, in most related arts, all non-sensing regions are completely removed, or the relevant conductive layer or the conductive layer or the dielectric layer is etched and only the substrate is retained. There is a significant optical difference between the sensing region and the non-sensing region, resulting in color difference. Therefore, an appearance of a pattern of the capacitor unit is easily recognized by naked eye, and an effect of concealing or transparentizing tag may not be achieved.

### SUMMARY

A purpose of the present disclosure is to provide a capacitive sensing identification tag, the capacitive sensing identification tag includes a substrate and a touch sensing layer disposed on the substrate for sensing by a capacitive touch panel. The touch sensing layer includes a plurality of high-sensing regions and a plurality of low-sensing regions with different shapes, and a distance between the high-sensing regions and the low-sensing regions is at least greater than 5 mm. Both the high-sensing regions and the low-sensing regions have different stacked conductive layers and dielectric layers. A difference between the high-sensing regions and the low-sensing regions is that each of the high-sensing regions contains a dielectric layer, while each of the low-sensing regions does not. The capacitive sensing identification tag achieves an effect of sampling and identification of a touch panel by a capacitive sensing quantity that is different from a capacitive touch panel. And the capacitive sensing identification tag will not cause a difference in color or light transmittance between the high-sensing regions and the low-sensing regions, so there is no visible difference between the high-sensing regions and the low-sensing regions. The present disclosure achieves an effect of concealing or transparentizing tag by the capacitive touch panel that may sense and identifying without visible difference.

In order to achieved the purpose, the capacitive sensing identification tag of the present disclosure includes a substrate and a touch sensing layer disposed on one side of the substrate. The touch sensing layer includes high-sensing regions and low-sensing regions. Each of the high-sensing regions includes a lower conductive layer and an upper conductive layer. A dielectric layer is sandwiched between each pair of the lower conductive layer and the upper conductive layer. Each of the low-sensing regions includes another lower conductive layer.

In an embodiment of the present disclosure, the substrate includes a non-conductive material with elasticity and light weight.

In an embodiment of the present disclosure, the non-conductive material includes at least one of plastic, paper, cardboard, wood, composite material, glass, ceramic, fabric, and leather.

In an embodiment of the present disclosure, the plastic includes polyvinyl chloride, polyethylene terephthalate-1,4-cyclohexanedimethanol, polyethylene or polyethylene terephthalate.

In an embodiment of the present disclosure, the capacitive sensing identification tag further includes an optical hardening layer disposed between the substrate and the lower conductive layer.

In an embodiment of the present disclosure, the optical hardening layer includes at least one of acrylic, epoxy, and silicon dioxide.

In an embodiment of the present disclosure, a thickness of the optical hardening layer is between 1 um and 10 μm.

In an embodiment of the present disclosure, the lower conductive layer is formed on one side of the optical hardening layer by evaporation, sputtering, printing, spraying or coating process.

In an embodiment of the present disclosure, a resistivity (sheet resistance) of the upper conductive layer and the lower conductive layer are both lower than 300 Ω/□.

In an embodiment of the present disclosure, both the upper conductive layer and the lower conductive layer include an organic conductor coating, an inorganic conductor coating or a combination thereof.

In an embodiment of the present disclosure, the inorganic conductor coating includes metal or metal oxide.

In an embodiment of the present disclosure, the organic conductor coating includes poly(3,4-ethylenedioxythiophene) polystyrene sulfonate (PEDOT:PSS), carbon nanotubes, or a combination thereof.

In an embodiment of the present disclosure, a resin composition mainly composed of PEDOT: PSS, which is coated and printed with organic conductive ink after being diluted, and the organic conductive ink includes a model PH1000 organic conductive ink with a solid content of 1.1% made by Heraeus Holding GmbH, or a model ICP 1050 organic conductive ink with a solid content of 1.1% made by Agfa-Gevaert N. V.

In an embodiment of the present disclosure, a light transmittance of the dielectric layer is between 70% and 95%.

In an embodiment of the present disclosure, a thickness of the dielectric layer is between 10 nm and 100 μm.

In an embodiment of the present disclosure, the dielectric layer is made by coating a transparent paint, and a dielectric constant of the dielectric layer is between 2 and 80.

In an embodiment of the present disclosure, the dielectric layer includes plastic resin, acrylic resin, aluminum oxide or silicon dioxide.

In an embodiment of the present disclosure, the plastic resin includes polymethyl methacrylate, polyether imide, polyvinylidene difluoride or polystyrene.

In an embodiment of the present disclosure, a distance between the high-sensing regions and the low-sensing regions of the touch sensing layer is at least greater than 5 mm.

In an embodiment of the present disclosure, a color difference (4E) between the high-sensing regions and the low-sensing regions of the touch sensing layer is less than 3.

In an embodiment of the present disclosure, a difference in light transmittance between the high-sensing regions and the low-sensing regions of the touch sensing layer is less than 7%.

### BRIEF DESCRIPTION OF THE DRAWINGS

FIG. 1A is a side view of a structure diagram with a substrate and a lower conductive layer of a capacitive sensing identification tag of the present disclosure;

FIG. 1B is a top view of FIG. 1A;

FIG. 2A is a schematic diagram of FIG. 1B making a dielectric layer on a surface of the lower conductive layer;

FIG. 2B is a top view of FIG. 2A;

FIG. 3A is a schematic diagram of FIG. 2B making an upper conductive layer on a surface of the dielectric layer;

FIG. 3B is a top view of FIG. 3A;

FIG. 4A is a side view structure diagram of the capacitive sensing identification tag structure of a comparative example 1 of the present disclosure; and

FIG. 4B is a top view of FIG. 4A.

### DETAILED DESCRIPTION

The technical content and detailed description of the present disclosure will be described below in conjunction with the drawings.

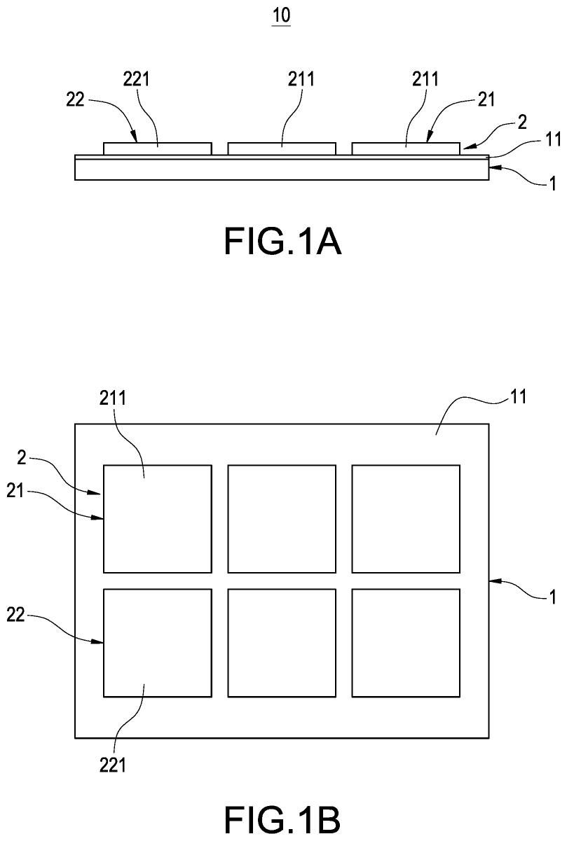

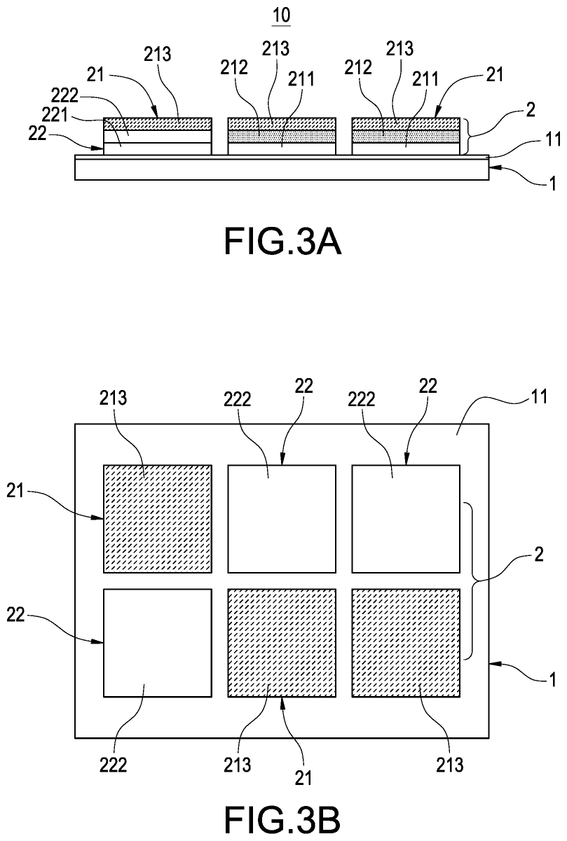

Please refer to FIGS. 1A and 1B. FIG. 1A is a side view of a structure diagram with a substrate and a lower conductive layer of a capacitive sensing identification tag of the present disclosure. FIG. 1B is a top view of FIG. 1A. Please also refer to FIG. 3B. As shown in the above figures, the capacitive sensing identification tag of the present disclosure is used for sensing by a capacitive touch panel. The capacitive sensing identification tag 10 includes a substrate 1 and a touch sensing layer 2 disposed on the substrate 1 for sensing by the capacitive touch panel. The touch sensing layer 2 includes a plurality of high-sensing regions 21 and a plurality of low-sensing regions 22 with different shapes. Each of the high-sensing regions 21 includes an upper conductive layer 213 and a lower conductive layer 211. A transparent dielectric layer 212 is sandwiched between each pair of the upper conductive layer 213 and the lower conductive layer 211. Each of the low-sensing regions includes at least one lower conductive layer 221, or both a lower conductive layer 221 and an upper conductive layer 222. Therefore, a color difference (ΔE) between the high-sensing regions 21 and the low-sensing regions 22 of the touch sensing layer is less than 3, or a difference in light transmittance between the high-sensing regions 21 and the low-sensing regions 22 of the touch sensing layer is less than 7%.

The substrate 1 includes plastic, paper, cardboard, wood, composite material, glass, ceramic, fabric, leather, or a combination thereof. The substrate 1 is a non-conductive material, especially a non-conductive material with elasticity and light weight. Further, the plastic includes polyvinyl chloride (PVC), polyethylene terephthalate-1,4-cyclohexanedimethanol/polyethylene terephthalate glycol (PETG), polyethylene (PE) or polyethylene terephthalate (PET). An optical hardening 11 layer with a thickness between 1 μm and 10 μm is disposed on one side of the substrate 1. The optical hardening layer 11 includes at least one of acrylic, epoxy, and silicon dioxide (SiO2).

The lower conductive layer 211, 221 is disposed on another side of the optical hardening layer 11 (on the side away from the substrate 1). The lower conductive layer 211, 221 are formed on another side of the optical hardening layer 11 of the substrate 1 by evaporation, sputtering, printing, spraying or coating process. A resistivity of the lower conductive layer 211 221 are both lower than 300Ω/□. Both the lower conductive layer 211 221 include at least one of an organic conductor coating and an inorganic conductor coating. The inorganic conductor coating includes metal or metal oxide. The organic conductor coating includes at least one of poly(3,4-ethylenedioxythiophene) polystyrene sulfonate (PEDOT: PSS) and carbon nanotubes. The organic conductor coating includes a resin composition mainly composed of PEDOT: PSS, which is coated and printed with organic conductive ink after being diluted, and the organic conductive ink includes a model PH1000 organic conductive ink with a solid content of 1.1% made by Heraeus Holding GmbH, or a model ICP 1050 organic conductive ink with a solid content of 1.1% made by Agfa-Gevaert N. V.

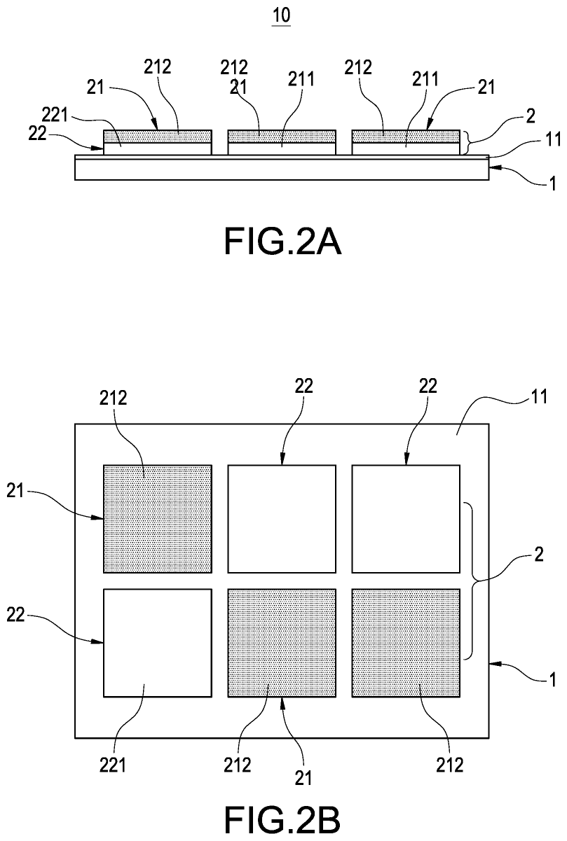

Please refer to FIGS. 2A and 2B. FIG. 2A is a schematic diagram of FIG. 1B making a dielectric layer on a surface of the lower conductive layer. FIG. 2B is a top view of FIG. 2A. As shown in the figures above, after the lower conductive layers 211, 221 are fabricated, another side of the specific lower conductive layer 211 (corresponding to the high-sensing region 21) is coated to form a dielectric layer 212 with a light transmittance between 70% and 95%, and a thickness of the dielectric layer 212 is between 10 nm and 100 μm.

The dielectric layer 212 is made by coating a transparent paint by evaporation, sputtering, printing, spraying or coating process, and a dielectric constant of the dielectric layer 212 is between 2 and 80. The dielectric layer 212 includes plastic resin, acrylic resin, aluminum oxide (Al2O3) or silicon dioxide (SiO2). The plastic resin includes polymethyl methacrylate (PMMA), polyether imide (PEI), polyvinylidene difluoride (PVDF) or polystyrene. The dielectric layer 212 is coated and printed by a PMMA resin paint (acrylic resin from Alfa Aesar), which is diluted with a solvent such as toluene beforehand.

Please refer to FIGS. 3A and 3B. FIG. 3A is a schematic diagram of FIG. 2B making an upper conductive layer on a surface of the dielectric layer. FIG. 3B is a top view of FIG. 3A. As shown in the figures above, after the dielectric layer 212 is fabricated, the upper conductive layers 213, 222 are formed on the dielectric layer 212 and another side of the lower conductive layer 221, respectively. The transparent dielectric layer 212 is sandwiched between the upper conductive layer 211 and the lower conductive layer 213 to form the high-sensing region 21. A single lower conductive layer 221 or a stack of the lower conductive layer 221 and the upper conductive layer 222 forms the low-sensing region 22.

The upper conductive layer 213 is formed on one side of dielectric layer 212 and lower conductive layer 221 by evaporation, sputtering, printing, spraying or coating process. A resistivity of the upper conductive layer 213 is lower than 300Ω/□. The upper conductive layer 213 includes at least one of an organic conductor coating and an inorganic conductor coating. The inorganic conductor coating includes metal or metal oxide. The organic conductor coating includes at least one of PEDOT: PSS and carbon nanotubes. The organic conductor coating includes a resin composition mainly composed of PEDOT: PSS, which is coated and printed with organic conductive ink after being diluted, and the organic conductive ink includes a model PH1000 organic conductive ink with a solid content of 1.1% made by Heraeus Holding GmbH, or a model ICP 1050 organic conductive ink with a solid content of 1.1% made by Agfa-Gevaert N. V.

In order to better understand a technical content of the present disclosure, the following embodiments are given for illustration:

### First Embodiment (as Shown in FIGS. 1A to 3B of the Present Disclosure)

The substrate 1 is a PET with a thickness of 125 μm and an area of 4×6 cm2, and an optical hardening layer 11 is made on one side of the substrate 1. Some sensing patterns of the touch sensing layer 2 are marked to be divided into the high sensing-regions 21 and the low-sensing regions 22, and a necessary distance between two adjacent sensing regions is at least greater than 5 mm. A printing method for the sensing regions is to print lower conductive layers 211, 221 with specific patterns on the substrate 1 by an inkjet printer on one side of the optical hardening layer 11. As to a printing method of the sensing region, the conductive layer 211, 221 under a specific pattern is printed by an inkjet printer on the side of the optical hardening layer 11 first on the substrate 1. The lower conductive layers 211, 221 are selected from model PH1000 organic conductive ink with a solid content of 1.1% made by Heraeus Holding GmbH, and the model PH1000 organic conductive ink is diluted with alcohol, and a viscosity of the model PH1000 organic conductive ink is controlled between 1 cps and 5 cps, and printed by inkjet printer. The patterns of the lower conductive layers 211, 221 are formed by baking at 150° C. for 5 minutes. And then, a part of the lower conductive layers 211 with specific patterns is selected, and the dielectric layer 212 is printed corresponding to a region of the lower conductive layers 211 with specific patterns. The dielectric layer 212 is printed by the inkjet printer prints the PMMA resin paint (acrylic resin from Alfa Aesar) diluted with a solvent such as toluene, and a viscosity of the PMMA resin paint is controlled between 1 cps and 5 cps. A pattern of the dielectric layer 212 is formed by baking at 150° C. for 5 minutes. Afterward, the method repeats the printing steps of making the lower conductive layer 211 as described above, and then the upper conductive layer 213 is printed of again. Similarly, the upper conductive layer 213 is selected from model PH1000 organic conductive ink with a solid content of 1.1% made by Heraeus Holding GmbH, and the model PH1000 organic conductive ink is diluted with alcohol, a viscosity of the model PH1000 organic conductive ink is controlled between 1 cps and 5 cps, and printed by inkjet printer. The patterns of the upper conductive layer 213 is formed by baking at 150° C. for 5 minutes.

In a completed structure of the capacitive sensing identification tag of the present disclosure, a structure in which the upper and lower conductive layers 213 and 211 sandwich a dielectric layer 212 is the high-sensing region 21, and a structure without the dielectric layer 212 between the two upper and lower conductive layers 222 and 221 is the low-sensing region 22.

### Second Embodiment

A manufacturing method of the second embodiment is partly the same as the first embodiment. A difference between the second embodiment and the first embodiment is that the dielectric layer 212 is formed at a coating position of the lower conductive layer 213, and the upper conductive layer 213 is formed. The upper conductive layer 222 is not formed in the low-sensing region 22.

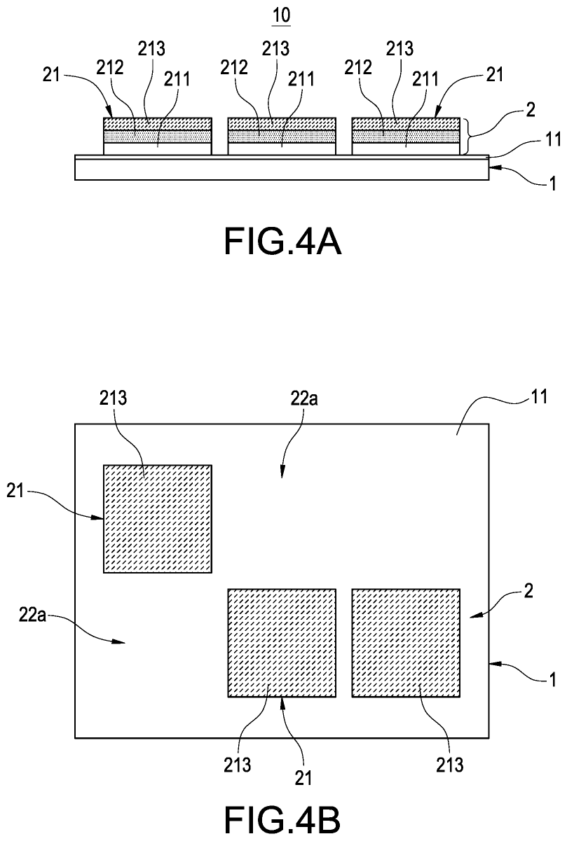

A comparative embodiment (as shown in FIGS. 4A and 4B of the present disclosure):

A manufacturing method of the comparative embodiment is similar to the first embodiment. A difference between the comparative embodiment and the first embodiment is that, in the comparative embodiment, the upper and lower conductive layers 222, 221 and the dielectric layer 212 are not printed at a position corresponding to the patterns on the low-sensing regions 22 to form non-sensing regions 22a.

Some related physical properties of the above embodiments and comparative embodiment are summarized as shown in the following table:

TABLE 1

| | first embodiment | | second embodiment | | comparative embodiment | |
|---|---|---|---|---|---|---|
| | high- | low- | high- | low- | high- | non- |
| | sensing | sensing | sensing | sensing | sensing | sensing |
| | region | region | region | region | region | region |
| sheet resistivity of | about 125 | about 125 | about 125 | about 125 | about 125 | N/A |
| conductive region | Ω/□ | Ω/□ | Ω/□ | Ω/□ | Ω/□ | |
| light transmittance | 82.7 | 83.5 | 82.9 | 86.9 | 82.7 | 93.1 |
| sensed sampling | YES | NO | YES | NO | YES | NO |
| reflection | −1.96/−5.9 | −1.57/−4.6 | −1.89/−5.2 | −1.14/−3.27 | −1.93/−5.7 | 0.4/0.8 |
| chromaticity | | | | | | |
| (a*/b*) | | | | | | |

| | | | |
|---|---|---|---|
| color difference | <1(It is difficult to distinguish | <2(It is not easy to identify | >4(The difference between |
| (ΔE) | the difference between the | the difference between the | the high-sensing region |
| | high-sensing region and the | high-sensing region and the | and the non-sensing region |
| | low-sensing region) | low-sensing region) | may be identified) |

Note:
1. Light transmittance measurement: Type NDH-5000 of the Nippon DENSHOKU company.
2. Sensed sampling: the capacitive sensing identification tag of the present disclosure is sensed by a mobile phone. The sensed sampling is obtained by sensing a change in capacitance according to a change in a specific position of a coupling sensing.
3. Reflective chromaticity (CIE a* and b*): Type CM-5 of the Minolta company detects CIE chromaticity.
4. Color difference (ΔE): After detecting CIE chromaticity with type CM-5 of the Minolta company, and then a color difference between the high-sensing regions and the low-sensing regions or a color difference between the high-sensing region and the non-sensing region being compared.

As can be seen from the results of the first and second embodiments for the capacitive sensing identification tag of the present disclosure, the color difference (4E) between the high-sensing regions and the low-sensing regions is visually non-identifiable. The recognition effect of the capacitive sensing identification tag of the first and second embodiments may be confirmed by the coupling inductive capacitance of the touch panel on the mobile phone, and by sensing a position of the sampling in a corresponding sensing area on the touch panel of the mobile phone.

A to the comparative embodiment, although the comparative embodiment may detect the sampling by the corresponding sensing area on the touch panel of the mobile phone, the comparative embodiment may easily identify the position of the high-sensing region through visual observation.

### Application Embodiment Instructions

The capacitive sensing identification tag of the present disclosure may be attached or printed directly on a packaging of general merchandise without affecting an appearance of the merchandise. A hand-held touch device such as a mobile phone (the mobile phone provides a built-in recognition software and a default database through a software setting) may be used. That is, one side of a touch screen of the mobile phone is attached to the capacitive sensing identification tag of the present disclosure. And then the touch screen of the mobile phone senses the identification tag to obtain a distribution pattern (totem) of a specific area, and compares the specific pattern in the default database to provide corresponding specific information. Finally, the specific information is transmitted to the touch screen of the mobile phone to obtain more information about the product, either for inventory management, or for convenience such as anti-counterfeiting identification.

Some technical contents are only some embodiments of the present disclosure, and is not used to limit the scope of the present disclosure. Any modification of the structure, the change of the proportional relationship, or the adjustment of the size should be within the scope of the technical contents disclosed by the present disclosure without affecting the effects and the achievable effects of the present disclosure.

What is claimed is:

1. A capacitive sensing identification tag comprising:
a substrate; and
a touch sensing layer disposed on one side of the substrate, the touch sensing layer comprising a plurality of high-sensing regions and a plurality of low-sensing regions;
wherein, each of the high-sensing regions comprises a lower conductive layer and an upper conductive layer; a dielectric layer is sandwiched between each pair of the lower conductive layer and the upper conductive layer; and each of the low-sensing regions comprises another lower conductive layer.

2. the capacitive sensing identification tag in claim 1, wherein, the substrate comprises a non-conductive material with elasticity and light weight.

3. the capacitive sensing identification tag in claim 2, wherein, the non-conductive material comprises plastic, paper, cardboard, wood, composite material, glass, ceramic, fabric, leather, or a combination thereof.

4. the capacitive sensing identification tag in claim 3, wherein, the plastic comprises polyvinyl chloride, polyethylene terephthalate-1,4-cyclohexanedimethanol, polyethylene or polyethylene terephthalate.

5. the capacitive sensing identification tag in claim 1, further comprising an optical hardening layer disposed between the substrate and the lower conductive layer.

6. the capacitive sensing identification tag in claim 5, wherein, the optical hardening layer comprises acrylic, epoxy, silicon dioxide or a combination thereof.

7. the capacitive sensing identification tag in claim 5, wherein, a thickness of the optical hardening layer is between 1 μm and 10 μm.

8. the capacitive sensing identification tag in claim 5, wherein, the lower conductive layer is formed on one side of the optical hardening layer by evaporation, sputtering, printing, spraying, or coating process.

9. the capacitive sensing identification tag in claim 1, wherein, a resistivity of the upper conductive layer and the lower conductive layer are both lower than 300 Ω/□.

10. the capacitive sensing identification tag in claim 1, wherein, both the upper conductive layer and the lower conductive layer comprise an organic conductor coating, an inorganic conductor coating, or a combination thereof.

11. the capacitive sensing identification tag in claim 10, wherein, the inorganic conductor coating comprises metal or metal oxide.

12. the capacitive sensing identification tag in claim 10, wherein, the organic conductor coating comprises poly(3,4-ethylenedioxythiophene) polystyrene sulfonate (PEDOT: PSS), carbon nanotubes, or a combination thereof.

13. the capacitive sensing identification tag in claim 12, wherein, a resin composition mainly composed of PEDOT: PSS, which is coated and printed with organic conductive ink after being diluted, and the organic conductive ink comprises a model PH1000 organic conductive ink with a solid content of 1.1% made by Heraeus Holding GmbH, or a model ICP 1050 organic conductive ink with a solid content of 1.1% made by Agfa-Gevaert N. V.

14. the capacitive sensing identification tag in claim 1, wherein, a light transmittance of the dielectric layer is between 70% and 95%.

15. the capacitive sensing identification tag in claim 1, wherein, a thickness of the dielectric layer is between 10 nm and 100 μm.

16. the capacitive sensing identification tag in claim 1, wherein, the dielectric layer is made by coating a transparent paint, and a dielectric constant of the dielectric layer is between 2 and 80.

17. the capacitive sensing identification tag in claim 1, wherein, the dielectric layer comprises plastic resin, acrylic resin, aluminum oxide or silicon dioxide.

18. the capacitive sensing identification tag in claim 17, wherein, the plastic resin comprises polymethyl methacrylate, polyether imide, polyvinylidene difluoride or polystyrene.

19. the capacitive sensing identification tag in claim 1, wherein, a distance between the high-sensing regions and the low-sensing regions of the touch sensing layer is at least greater than 5 mm.

20. the capacitive sensing identification tag in claim 1, wherein, a color difference between the high-sensing regions and the low-sensing regions of the touch sensing layer is less than 3.

21. the capacitive sensing identification tag in claim 1, wherein, a difference in light transmittance between the high-sensing regions and the low-sensing regions of the touch sensing layer is less than 7%.
